(19) United States
(12) Patent Application Publication
(10) Pub. No.: US 2013/0091265 A1
(43) Pub. Date: Apr. 11, 2013

(54) METHOD FOR DETERMINING A PROFILE FOR A USER/APPLICATION SERVICE PAIR TO ACCESS DATA RELATED TO THE OPERATION OF A COMMUNICATION NETWORK

(71) Applicants: Lounes Baleh, Rennes (FR); Lucian Suciu, Cesson-Sevigne (FR)

(72) Inventors: Lounes Baleh, Rennes (FR); Lucian Suciu, Cesson-Sevigne (FR)

(73) Assignee: FRANCE TELECOM, PARIS (FR)

(21) Appl. No.: 13/700,812

(22) PCT Filed: May 31, 2011
(86) PCT No.: PCT/FR11/51236

§ 371 Date: Nov. 29, 2012

(30) Foreign Application Priority Data
Jun. 3, 2010 (FR) 1054356

(51) Int. Cl. G06F 15/173

(52) U.S. Cl. CPC G06F 15/173
USPC 709/223

(57) ABSTRACT

A method for determining a profile for a user/application service pair to access data related to the operation of a communication network, or operation data, said data being needed in order to implement the application service at an application layer of a communication device. The method includes a step of determining the access profile on the basis of information related to a service level corresponding to the user/application service pair and on the basis of information related to an access policy associated with the operation data required by the application service. Said method also includes a step of storing the access profile related to the user/application service pair.

The invention relates to the field of telecommunications and, more particularly, to the field of application services implemented by a wireless communications device.

The diversification of access technologies and the emergence of new operating systems for communications devices, such as for example “smartphones”, allow the development of application services such as services allowing e-mails to be consulted, geo-positioning, online games, video conferencing services, services associated with social networks or with professions (medical profession, marketing, logistics, etc.).

Such application services are implemented within an application layer of the communications device.

The OSI (Open System Interconnection) model standardized by the ISO (International Standards Organization) defines the management of the data transfer by means of seven superposed protocol layers: the physical layer (layer 1), the data link layer (layer 2), the network layer (layer 3), the transport layer (layer 4), the session layer (layer 5), the presentation layer (layer 6) and the application layer (layer 7).

The implementation of such application services requires access to certain pieces of communication equipment belonging to a communications network such as localization servers, mail servers or video-conferencing servers. The access to these servers is made possible by the use of an application programming interface or API. Such an interface comprises a library of functions, procedures, etc. allowing the implementation of application services. Examples of application programming interfaces or APIs are defined in the series of documents ES 204 915 published by the ETSI.

When a communications device implements an application service, it sends a request to the communication equipment via the application programming interface API in order to access operating data of the network and to control functionalities of the network.

In order to manage the access of the application services to the operating data and in order to preserve the security of the communications network of which he is the manager, the operator and the supplier of application services define, for various categories of application services, an access profile comprising a set of communication equipment which the application services can access and a set of functionalities of the network that the application services can control through the API interface after authentication. Such an access profile is common to all of the application services belonging to the same category of application services or to well-defined sub-categories of these application services.

Such a solution lacks flexibility and does not allow the operator manager of the communications network to adapt his solution to the changing requirements and to manage his communications network in an optimal manner.

One of the aims of the invention is to overcome drawbacks of the prior art.

For this purpose, the invention provides a method for determining a profile for a user/application service pair to access data relating to the operation of a communications network, or operating data, necessary for the implementation of the application service within an application layer of a communications device, the procedure comprising:
a step for determining the access profile based on information relating to a level of service associated with a user/application service pair, and based on information relating to an access policy associated with the operating data required by the application service.
a step for storing the access profile relating to the user/application service pair.

Such a solution allows the development of these application services and an improvement, for example, in the quality of experience QoE of the users of the application services, by authorizing the access to certain data of the communications network to third-party application service providers.

Indeed, in this solution, the access of the application services to the operating data takes place depending on information relating to an access policy associated with the operating data required by the application service. Such information consists of security, filtering or mapping rules or else policies established by the operator managing the communications network prior to the deployment of an application service. The determination of an access profile for each new user/application service pair allows the security of the communications network to be guaranteed by only giving access to the operating data necessary for the implementation of the application service.

Such operating data are for example metrics associated with the quality of service (rate, timing, packet loss), metrics linked to the performance characteristics of the mobility protocols, metrics linked to the caches/storage within the communications network, metrics linked to the processing capacities (CPU) in the communications network, metrics linked to the transcoding/adaptation functions, etc.

The same application service can have a profile associated with it for access to different operating data depending on the user that is associated with it. Thus, the level of service associated with the user/application service pair is defined between the application services provider, the user and the manager of the communications network.

Such a method for determining an access profile allows access to the operating data of the communications network to be offered to an application service in a customized manner and allows the network operator to progressively adapt his solution to the demand and to the market, and to manage his network in an optimal manner.

According to one feature of the determination method, the latter comprises, prior to the step for generation of the access profile, a first step for updating the information relating to an access policy.

The determination method thus allows more flexibility to be offered in the use and the deployment of application services by allowing the addition of new policies and of new filters.

According to one feature of the determination method, the latter comprises a step for authentication of the user/application service pair prior to the determination of the access profile of the user/application service pair.

The invention also relates to a method for access of the application service to data relating to the operation of a communications network, or operating data, necessary for the implementation of the application service within an application layer of a communications device, the method comprising:
a first step for interrogating a database comprising a profile for access to the operating data associated with a user/application service pair, the access profile of the application service being generated based on information relating to a level of service associated with a user/application service pair, and on information relating to an access policy associated with the operating data required by the application service,
a second step for interrogating equipment belonging to a communications network having a knowledge of the operating data conforming to the access profile,
a step for transmitting the operating data to the communications device.

The invention furthermore relates to an equipment item belonging to a communications network comprising a module capable of determining a profile for a user/application service pair to access data relating to the operation of the communications network, or operating data, necessary for the implementation of the applications service within an application layer of a communications device, the module comprising:
means for determining the access profile based on information relating to a level of service associated with the user/application service pair and on information relating to an access policy associated with the operating data required by the application service,
means for storing the access profile relating to the user/application service pair.

According to one feature of the equipment, the latter also comprises a module for the application service to access the operating data, and the access module comprises:
first means for interrogating a database comprising the profile for access to the operating data associated with the application service,
second means for interrogating the equipment belonging to the communications network having a knowledge of the operating data conforming to the access profile.
means for transmitting the operating data to the communications device.

According to other aspects, the invention also relates to computer programs comprising program code instructions for the implementation of the steps, determination and access methods described previously, when these programs are executed by a computer.

Each of the computer programs described above can use any given programming language, and be in the form of source code, object code, or code intermediate between source code and object code, such as in a partially compiled form, or in any other desirable form.

The invention is also aimed at a recording medium readable by a computer on which a computer program such as previously described is recorded.

The information medium can be any given entity or device capable of storing the program. For example, the medium can comprise a storage means, such as a ROM (for “Read Only Memory”), for example a CD ROM or a microelectronic circuit ROM, or a means for magnetic recording, for example a floppy disk or a hard disk.

On the other hand, the information medium can be a transmissible medium such as an electrical or optical signal, which can be transmitted via an electrical or optical cable, by radio or by other means. The program according to the invention can be in particular uploaded onto/downloaded from a network of the Internet type.

Alternatively, the information medium can be an integrated circuit into which the program is incorporated, the circuit being designed to execute or to be used in the execution of the method in question.

Other characteristics and advantages will become apparent upon reading embodiments described with reference to the drawings in which:

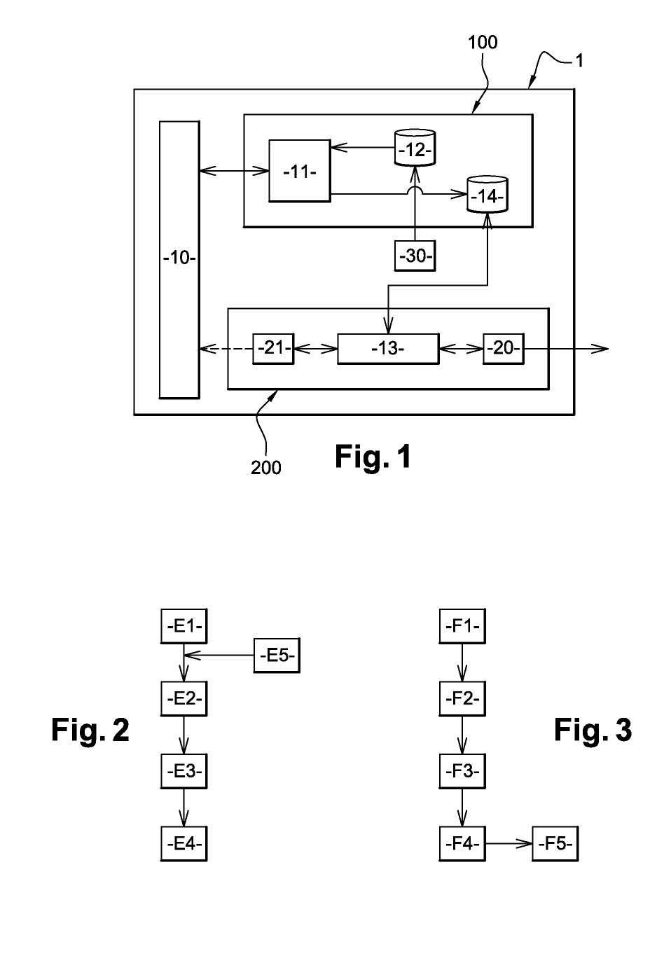

FIG. 1 shows a communications device belonging to a communications network and comprising a module capable of determining a profile for a user/application service pair to access data relating to the operation of a communications network, necessary for the implementation of the application service and a module for the application service to access the operating data,

FIG. 2 shows the steps of a method for determining the profile for the application service to access the operating data,

FIG. 3 shows the steps of a method for accessing the operating data necessary for the implementation of the application service,

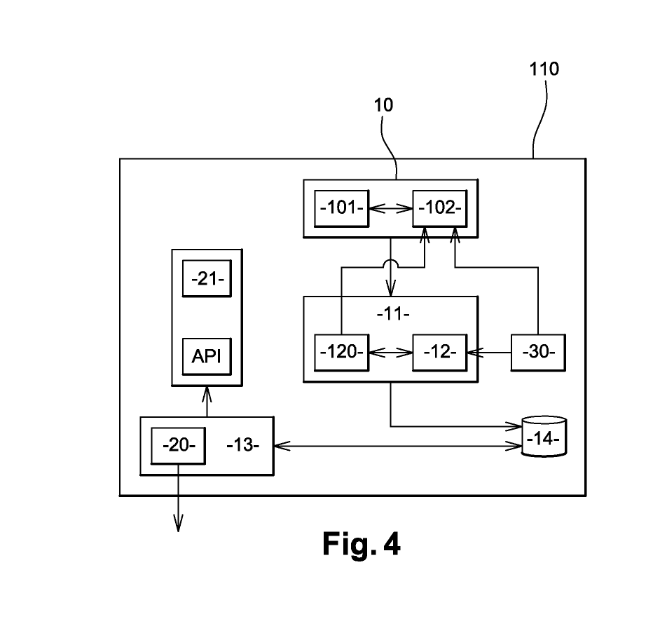

FIG. 4 shows a communications equipment item belonging to a communications network and comprising a module capable of determining a profile for a user/application service pair to access data relating to the operation of a communications network, necessary for the implementation of the application service and a module for the application service to access the operating data according to one particular embodiment of the invention,

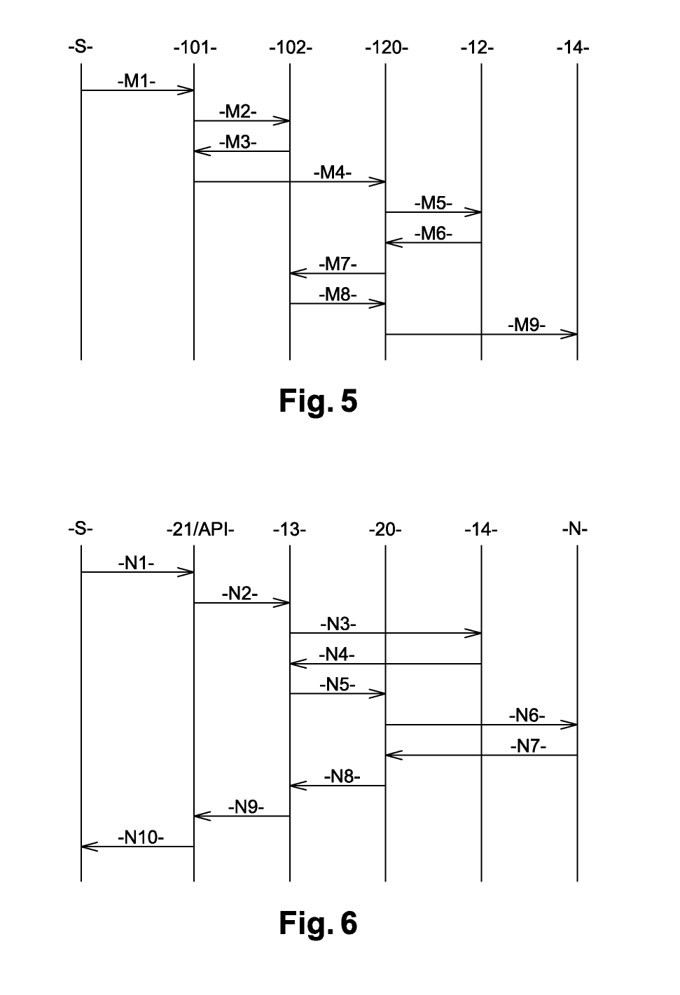

FIG. 5 shows the steps of the determination method when the latter is implemented in the communication equipment item in FIG. 4.

FIG. 6 shows the steps of the access method when the latter is implemented in the communication equipment item in FIG. 4.

FIG. 1 shows a communications device 1 belonging to a communications network allowing an application service associated with a user to access data relating to the operation of the communications network, or operating data, necessary for the implementation of the application service within an application layer of a communications device managed by the user not shown in FIG. 1.

Such a communications equipment item 1 comprises means 10 for authentication of the user/application service pair. Such authentication means 10 are for example authentication, authorization and accounting means (AAA) such as a RADIUS server associated with a database comprising information relating to a level of service associated with the user/application service pair.

Such authentication means 10 are connected to the input of the means 11 for generating an access profile for a user/application service pair. The generation means 11 generate an access profile based on the information relating to a level of service associated with the user/application service pair and on the information relating to an access policy associated with the operating data required by the application service. The information relating to the access policy is stored in a database 12. An access profile comprises a list of access rights to operating data of the communications network such as metrics linked to the quality of service (rate, timing, packet loss), metrics linked to the performance characteristics of the mobility protocols, metrics linked to the caches/storage within the communications network, metrics linked to the processing capacities (CPU) within the communications network, metrics linked to transcoding/adaptation functions, etc. Such an access profile for a user/application service pair can vary over time. It can, for example, be different depending on the time of day.

The access profile thus obtained is stored in storage means 14 connected to the generation means 11.

The communication equipment item 1 also comprises a module 200 for the application service to access the operating data.

Such an access module 200 comprises first means 13 for interrogation of the storage means 14 in order to gain access to the access profile for the user/application service pair.

The first interrogation means 13 are connected to second means 20 for interrogating equipment (not shown in the figure) belonging to the communications network. The second interrogation means 20 interrogate the equipment of the network in order to access the operating data of the network. The second interrogation means 20 interrogate the equipment of the network having a knowledge of the operating data for which the application service possesses access rights such as defined in the access profile for the user/application service pair.

The first interrogation means 13 are also connected to means 21 for transmitting the operating data to the communications device. In one embodiment of the invention, the transmission means 21 can be connected to the authentication means 10.

Lastly, the communication equipment item 1 comprises means 30 for updating the database 12.

FIG. 2 shows the steps of a method for determining a profile for a user/application service pair to access data relating to the operation of a communications network. The steps of this determination method are implemented by the communication equipment 1.

Thus, during a step E1, an application service associated with a user having a need to access data relating to the operation of the communications network gets authenticated by the authentication means 10 of the communication equipment item 1.

Once the user/service pair has been authenticated by the authentication means 10, during a step E2, the generation means 11 interrogate the database 12 in order to obtain information relating to a level of service associated with the user/application service pair and information relating to an access policy associated with the operating data required by the application service when it is implemented.

Using this information, during a step E3, the generation means 11 generate an access profile for the user/application service pair.

The access profile thus obtained is stored, during a step E4, in the storage means 14.

Such a method for determining an access profile allows the deployment of new application services implemented in communications networks.

The access of the application services to the operating data takes place according to information relating to an access policy associated with the operating data required by the application service such as rules on security, filtering or else policies established by the operator managing the communications network prior to the deployment of an application service. The database 12 can also comprise invoicing information to be applied to the provider of application services or to the user. The determination of an access profile for each new user/application service pair allows the security of the communications network to be guaranteed.

In order to offer more flexibility in the use and the deployment of the application services, it is advantageous to be able to add new policies and new filters or to update this information.

Thus, during a step E5, the updating means 30 update the information comprised in the database 12.

The steps E2 to E4 are then again implemented in order to take into account the modifications applied to the determination of the access profile for the user/application service pair.

FIG. 3 shows the steps of a method for an application service to access data relating to the operation of a communications network. The steps of this access method are implemented by the communication equipment item 1.

During a step F1, an application service associated with a user trying to access data relating to the operation of the communications network gets itself authenticated by the authentication means 10 of the communication equipment item 1.

Once the application service has been authenticated, the first interrogation means 13 interrogate the storage means 14 during a step F2.

The result of this interrogation is the profile for access to the operating data associated with the user/application service pair.

During a step F3, the transmission means 21 are connected to the application service. Such a connection consists for example in the establishment of a secure connection such as a VPN (Virtual Private Network) connection between the communications device and the communication equipment item 1.

Once the access profile for the user/application service pair is known, during a step F4, the second interrogation means 20 interrogate equipment of the network.

The transmission means 21 transmit the operating data obtained during the step F4 to the communications device, during a step F5.

FIG. 4 shows a communication equipment item 110 according to one particular embodiment of the invention.

Such a communication equipment item 110 comprises means 10 for authenticating the user/application service pair. Such authentication means 10 comprise means 101 for processing an authentication request generated by an application service associated with a user, such as a server AAA. The processing means 101 verify the identity of the user associated with the application service by interrogating a database 102 comprising information relating to the user/application service pair such as a level of service. In one embodiment, the user is the application services provider.

In another embodiment, the processing means 101 can also verify the access rights of the user/application service pair to the operating data.

If the application service has the right to access operating data, the processing means 101 transmit the access request to the generation means 11 to which the authentication means 10 are connected.

The generation means 11 comprise the database 12 in which filters, invoicing rules and policies to be applied to each user/application service pair are stored. A filter specifies the operating data to which the user/application service pair has the right of access. A policy specifies for example the access technology with which an application service can be deployed.

The generation means 11 comprise means 120, connected to the database 102 and to the database 12, for coordinating information comprised in these two databases. The coordination means 120 generate the access profile for the user/application service pair.

The coordination means 120 take into consideration the policies established by the operator managing the communications network and the information relating to the invoicing, together with the filters to be used for the application service for generating the access profile.

In one particular embodiment of the invention, once the access profile has been generated, the generation means 11 inform the authentication means 10 of the fact that the application service can have access to the operating data via transmission means 21 and interrogation means 20.

The access profile thus obtained is stored in storage means 14 connected to the generation means 11.

The communication equipment item 1 comprises first means 13 for interrogation of the storage means 14 in order to gain access to the access profile for the user/application service pair.

The first interrogation means 13 are connected to second means 20 for interrogation of equipment (not shown in the figure) belonging to the communications network. The second interrogation means 20 interrogate equipment of the network in order to access the operating data of the network. The second interrogation means 20 interrogate equipment of the network having a knowledge of the operating data for which the application service possesses access rights as defined in the access profile for the user/application service pair.

The first interrogation means 13 are also connected to means 21 for transmission of the operating data to the communications device.

The transmission means 21 are responsible for exchanges with the application service during its implementation via an API interface.

Lastly, the communication equipment item 1 comprises means 30 for updating the databases 102 and 12.

FIG. 5 shows the steps of the determination method when the latter is implemented in the communication equipment item 110.

An application service S wishing to gain access to operating data of the network sends an access request to the processing means 101 during a step M1.

The processing means 101 transmit an interrogation message, during a step M2, to the database 102 in order to verify the identity of the user associated with the application service.

This information is transmitted to the processing means 101 in a step M3.

If the user of the application service has the right to access the operating data, the processing means 101 transmit the access request to the coordination means 120 during a step M4.

During a step M5, the coordination means 120 interrogate the database 12 in which filters and policies to be applied to each user/application service pair, and where appropriate information relating to invoicing, are stored. This information is transmitted to the coordination means 120 during a step M6.

During a step M7, the coordination means 120 interrogate the database 102 comprising information relating to the user/application service pair such as a level of service. This information is transmitted to the coordination means 120 during a step M8.

The coordination means 120 take into consideration the various pieces of information received during steps M6 and M8 for generating the access profile for the user/application service pair.

During a step M9, the access profile thus generated is stored in the storage means 14.

FIG. 6 shows the steps of the access method when the latter is implemented in the communication equipment item 110.

During a step N1, an application service S trying to access operating data of the communications network transmits an access request to the transmission means 21 of the communication equipment item 110.

Such a request is transmitted to the first interrogation means 13 during a step N2. The first interrogation means 13 interrogate the storage means 14 during a step N3.

During a step N4, the storage means 14 transmit the profile for access to the operating data associated with the application service to the first interrogation means 13.

The first interrogation means 13 process the request transmitted during the step N1 according to the access profile obtained during the step N4 and transmit the result to the second interrogation means 20 during a step N5.

During a step N6, the second interrogation means 20 interrogate the equipment of the network N having a knowledge of the operating data for which the application service possesses access rights such as defined in the access profile for the user/application service pair.

The equipment of the network N in question transmits the required operating data to the second interrogation means 20 during a step N7.

The second interrogation means 20 in turn transmit the obtained operating data to the first interrogation means 13, during a step N8. The first interrogation means 13 then apply the filters defined by the access profile. The first interrogation means 13 then transmit to the transmission means 21, during a step N9, the operating data thus processed. In another embodiment of the invention, the second interrogation means 20 may also request the equipment of the network to execute certain commands requested by the application service.

Once the access profile for the application service is known, the transmission means 21 transmit the operating data to the communications device during a step N10 and receive the commands from the application service.

1. A method for determining a profile for a user/application service pair to access data relating to the operation of a communications network, or operating data, necessary for the implementation of the application service within an application layer of a communications device, the method comprising:
a step for determination of the access profile based on information relating to a level of service associated with a user/application service pair and on information relating to an access policy associated with the operating data required by the application service,
a step for storage of the access profile relating to the user/application service pair.

2. The determination method as claimed in claim 1, comprising, prior to the step for generation of the access profile, a step for updating the information relating to an access policy.

3. The determination method as claimed in claim 1, comprising a step for authentication of the application service prior to the determination of the access profile for the application service.

4. A method for an application service to access data relating to the operation of a communications network, or operating data, necessary for the implementation of the application service within an application layer of a communications device, the method comprising:
a first step for interrogation of a database comprising a profile for access to the operating data associated with a user/application service pair, the access profile for the user/application service pair being generated based on information relating to a level of service associated with the user/application service pair and on information relating to an access policy associated with the operating data required by the application service,
a second step for interrogation of equipment belonging to the communications network having a knowledge of the operating data conforming to the access profile,
a step for transmission of the operating data to the communications device.

5. An equipment item belonging to a communications network comprising a module capable of determining a profile for a user/application service pair to access data relating to the operation of the communications network, or operating data, necessary for the implementation of the application service within an application layer of a communications device, the module comprising:
means for determination of the access profile based on information relating to a level of service associated with the user/application service pair and on information relating to an access policy associated with the operating data required by the application service,
means for storing the access profile relating to the user/application service pair.

6. The equipment item as claimed in claim 5, comprising a module for the application service to access the operating data, the access module comprising:
first means for interrogating a database comprising the profile for access to the operating data associated with the application service,
second means for interrogating equipment belonging to the communications network having a knowledge of the operating data conforming to the access profile,
means for transmitting the operating data to the communications device.

7. A non-transitory computer program product comprising program code instructions for the implementation of the steps of the determination method as claimed in claim 1, when the program is executed by a processor.

8. A recording medium readable by communication equipment on which the program as claimed in claim 7 is recorded.

9. A non-transitory computer program product comprising program code instructions for the implementation of the steps of the access method as claimed in claim 4, when the program is executed by a processor.

10. A recording medium readable by a communication equipment on which the program as claimed in claim 9 is recorded.
